(19) United States
(12) Patent Application Publication
(10) Pub. No.: US 2018/0231904 A1
(43) Pub. Date: Aug. 16, 2018

(54) ELECTROPHOTOGRAPHIC COMPOSITION

(71) Applicant: HP Indigo B.V., Amstelveen (NL)

(72) Inventors: Tony Azzam, Nazareth (IL); Ilanit Mor, Kiryat Ono (IL); Albert Teishev, Rishon le-zion (IL); Samer Farran, Nes Ziona (IL); Getahun Biadglin, Beth-She'an (IL); Haim Cohen, Modiin (IL); Guy Nesher, Nes Ziona (IL); Igor Shutyi, Nes Ziona (IL); Eyal Shelef, Tel Aviv (IL)

(21) Appl. No.: 15/754,210

(22) PCT Filed: Oct. 10, 2016
(86) PCT No.: PCT/EP2016/074241

§ 371 Date: Feb. 21, 2018

(30) Foreign Application Priority Data
Oct. 23, 2015 (EP) PCT/EP2015/074663

(51) Int. Cl. G03G 9/13; G03G 9/135; G03G 9/08

(52) U.S. Cl. CPC G03G 9/131; G03G 9/0804; G03G 9/1355

(57) ABSTRACT

The present disclosure relates to an electrophotographic composition. The composition comprises composite particles comprising particles of wax dispersed in a matrix comprising an olefin polymer having acid and/or ester side groups. The wax has a melting point of at least 130 degrees C.

### BACKGROUND

An electrophotographic printing process involves creating an image on a photoconductive surface or photo imaging plate (PIP). The image that is formed on the photoconductive surface is a latent electrostatic image having image and background areas with different potentials. When an electrophotographic ink composition containing charged toner particles is brought into contact with the selectively charged photoconductive surface, the charged toner particles adhere to the image areas of the latent image while the background areas remain clean. The image is then transferred to a print substrate (e.g. paper) either directly or by first being transferred to an intermediate transfer member (e.g. a soft swelling blanket) and then to the print substrate.

### BRIEF DESCRIPTION OF THE FIGURES

Various features will be described, by way of example only, with reference to the following FIGURE:

FIG. 1 compares the peel performance of an unvarnished image with the peel performance of an image varnished with the electrophotographic varnish composition of Example 1 (see Example 6).

### DETAILED DESCRIPTION

Before the present disclosure is disclosed and described, it is to be understood that this disclosure is not limited to the particular process steps and materials disclosed in this disclosure because such process steps and materials may vary. It is also to be understood that the terminology used in this disclosure is used for the purpose of describing particular examples. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used in this disclosure, “carrier fluid”, “carrier liquid,” “carrier,” or “carrier vehicle” refers to the fluid in which polymers, particles, charge directors and other additives can be dispersed to form a liquid electrostatic composition or liquid electrophotographic composition. The carrier liquids may include a mixture of a variety of different agents, such as surfactants, co-solvents, viscosity modifiers, and/or other possible ingredients.

As used in this disclosure, “liquid electrophotographic composition” or “liquid electrostatic composition” generally refers to a composition, which is suitable for use in an electrophotographic or electrostatic printing process. The liquid electrophotographic composition may comprise chargeable particles of a resin dispersed in a carrier liquid. The liquid electrophotographic composition may or may not comprise a colorant.

As used in this disclosure, “co-polymer” refers to a polymer that is polymerized from at least two monomers. The term “terpolymer” refers to a polymer that is polymerized from 3 monomers.

As used in this disclosure, “melt index” and “melt flow rate” are used interchangeably. The “melt index” or “melt flow rate” refers to the extrusion rate of a resin through an orifice of defined dimensions at a specified temperature and load, reported as temperature/load, e.g. 190° C./2.16 kg. In the present disclosure, “melt flow rate” or “melt index” is measured per ASTM D1238-04c Standard Test Method for Melt Flow Rates of Thermoplastics by Extrusion Plastometer. If a melt flow rate of a particular polymer is specified, unless otherwise stated, it is the melt flow rate for that polymer alone, in the absence of any of the other components of the electrostatic composition.

As used in this disclosure, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used in this disclosure, “melt viscosity” generally refers to the ratio of shear stress to shear rate at a given shear stress or shear rate. Testing may be performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa-s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

A polymer may be described as comprising a certain weight percentage of monomer. This weight percentage is indicative of the repeating units formed from that monomer in the polymer.

If a standard test is mentioned in this disclosure, unless otherwise stated, the version of the test to be referred to is the most recent at the time of filing this patent application.

As used in this disclosure, “electrostatic printing” or “electrophotographic printing” refers to the process that provides an image that is transferred from a photo imaging plate either directly or indirectly via an intermediate transfer member to a print substrate. As such, the image may not be substantially absorbed into the photo imaging substrate on which it is applied. Additionally, “electrophotographic printers” or “electrostatic printers” refer to those printers capable of performing electrophotographic printing or electrostatic printing, as described above. An electrophotographic printing process may involve subjecting the electrophotographic composition to an electric field, e.g. an electric field having a field gradient of 50-400V/μm, or more, in some examples 600-900V/μm, or more.

As used in this disclosure, “substituted” may indicate that a hydrogen atom of a compound or moiety is replaced by another atom such as a carbon atom or a heteroatom, which is part of a group referred to as a substituent. Substituents include, for example, alkyl, alkoxy, aryl, aryloxy, alkenyl, alkenoxy, alkynyl, alkynoxy, thioalkyl, thioalkenyl, thioalkynyl, thioaryl, etc.

As used in this disclosure, “heteroatom” may refer to nitrogen, oxygen, halogens, phosphorus, or sulfur.

As used in this disclosure, “alkyl”, or similar expressions such as “alk” in alkaryl, may refer to a branched, unbranched, or cyclic saturated hydrocarbon group, which may, in some examples, contain from 1 to about 50 carbon atoms, or 1 to about 40 carbon atoms, or 1 to about 30 carbon atoms, or 1 to about 10 carbon atoms, or 1 to about 5 carbon atoms, for example.

The term “aryl” may refer to a group containing a single aromatic ring or multiple aromatic rings that are fused together, directly linked, or indirectly linked (such that the different aromatic rings are bound to a common group such as a methylene or ethylene moiety). Aryl groups described in this disclosure may contain, but are not limited to, from 5 to about 50 carbon atoms, or 5 to about 40 carbon atoms, or 5 to 30 carbon atoms or more, and may be selected from, phenyl and naphthyl.

Unless the context dictates otherwise, the terms “acrylic” and “acrylate” refer to any acrylic or acrylate compound. For example, the term “acrylic” includes acrylic and methacrylic compounds unless the context dictates otherwise. Similarly, the term “acrylate” includes acrylate and methacrylate compounds unless the context dictates otherwise.

As used in this disclosure, “varnish” in the context of the present disclosure refers to substantially colourless, clear or transparent compositions substantially free from pigment or other colorants. As the compositions are substantially free from pigment or other colorants, they may be used as varnishes in the methods described herein without contributing a further subtractive effect on the CMYK inks that would substantially affect the colour of an underprinted coloured image. It will be understood that other effects such as gamut expansion, saturation and brightness nevertheless may be enhanced.

As used in this disclosure, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description in this disclosure.

As used in this disclosure, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented in this disclosure in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not just the explicitly recited values of about 1 wt % to about 5 wt %, but also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used in this disclosure, wt % values are to be taken as referring to a weight-for-weight (w/w) percentage of solids in the composition, and not including the weight of any carrier fluid present.

The present disclosure relates to an electrophotographic composition that comprises composite particles. The composite particles comprise particles of wax dispersed in a matrix of an olefin polymer having acid and/or ester side groups. The wax has a melting point of at least 130 degrees C. The wax may form 1 to 10 weight % of the total weight of the composite particles.

The present disclosure also relates to a method of producing an electrophotographic composition. The process comprises mixing wax with a molten resin comprising an olefin polymer having acid and/or ester side groups; allowing the mixture to cool to form a matrix comprising an olefin polymer having acid and/or ester side groups surrounding dispersed particles of solid wax; grinding the resulting mixture to form composite particles, and dispersing the composite particles in a liquid carrier, wherein the wax has a melting point that is higher than the melting point of the olefin polymer in the matrix.

The present disclosure also provides the use of a wax having a melting point of at least 130 degrees C. to improve the adhesion of a varnished electrophotographically printed image onto a print medium.

It has been found that some electrophotographic inks do not have the desired degree of durability, for example, in peel, scratch and/or rub tests, when printed on certain print substrates. This can sometimes be addressed by applying an electrophotographic varnish over the printed ink. Such varnishes can improve the durability of the image, for example, by improving its scratch resistance. However, varnishes can decrease the peel resistance of the printed image. It has been found that, by forming composite particles containing particles of wax dispersed in a matrix, it is possible to improve the adhesion or peel resistance of the image.

### Wax

As discussed above, the composite particles comprise particles of a wax dispersed in a matrix of an olefin polymer having acid and/or ester side groups. Any suitable wax may be employed. For example, the wax may be a synthetic wax. The wax may be a paraffin wax or a non-paraffinic wax. By “paraffin wax”, it is meant any wax that comprises a long chain hydrocarbyl component, for example, a hydrocarbyl component having at least 8, at least 10 or at least 12 carbon atoms. In some examples, the hydrocarbyl component may be an alkyl component having a carbon chain length of, for example, at least 12 carbon atoms.

In one example, the wax may comprise at least 12 carbon atoms, for instance, at least 15 carbon atoms. The wax may comprise 16 to 60 carbon atoms, for example, 18 to 50 carbon atoms or 20 to 40 carbon atoms.

The wax may comprise at least one hydrocarbyl (e.g. alkyl) group having at least 12 carbon atoms, for example, at least 16 carbon atoms. In one example, the wax may comprise at least one hydrocarbyl (e.g. alkyl) group having 12 to 22 carbon atoms, for example, 16 to 20 carbon atoms. In one example, the wax may comprise at least one (e.g. 2) 018 alkyl groups.

The paraffin wax may be functionalised, for example, the wax may comprise a long chain hydrocarbyl (e.g. alkyl) group that is functionalised with amide functionality.

In some examples, the wax comprises an amide group. In one example, the wax is an amide of a fatty acid. In one example, the wax is a reaction product of a diamine and a fatty acid. For example, the wax may be a reaction product of an olefin diamine and a fatty acid. An example of a suitable olefin is ethylene diamine. Suitable fatty acids include fatty acids having 10 to 30 carbon atoms, for example, 15 to 25 or 16 to 20 carbon atoms. An example of a suitable fatty acid is stearic acid. In one example, the wax may be ethylene bis(stearamide).

The wax has a melting point of at least 130 degrees C., for example, at least 135 degrees C. In some examples, the wax has a melting point of 130 to 190 degrees C., for instance, 135 to 160 degrees C. In other examples, the wax has a melting point of 140 to 150 degrees C., for instance, 140 to 145 degrees C. In one example, the wax is a synthetic wax having a melting point of 135 to 150 degrees C. By way of example, a wax sold under the trademark LANCO® 1400 SF (Lubrizol®) may be employed.

The melting point of the wax may be higher than the melting point of the polymer or polymer mixture forming the matrix. Where more than one polymer is present in the matrix, the melting point of the wax may be higher than each polymer in the matrix. In some examples, the melting point of the wax may be higher than the melting point of the polymer or polymer mixture by at least 10 degrees or 20 degrees C., for example, at least 30 degrees C. In some examples, the melting point of the wax may be higher than the melting point of the polymer or polymer mixture by at least 40 degrees C., for example, at least 50 degrees C.

The wax may include a mixture of two or more waxes. The mixture may have a melting point of at least 130 degrees C.

The wax in the composite particles may be a powder dispersed in the matrix. The powder may be micronized. The powder may have a particle size of 0.5 to 10 microns, for example, 1 to 5 microns.

The wax may be present in an amount of 1 to 10 weight % based on the total weight of the composite particles. In some examples, the wax may be present in an amount of 4 to 6 weight %, for instance, 5 weight %.

The particles of wax dispersed in the matrix of an olefin polymer may have a particle size of 0.05 to 10 microns, for example, 0.1 to 5 microns. In one example, the particles of wax dispersed in the matrix may have a particle size of 2 to 4 microns, for instance, about 3 microns. In one example, the particles of wax dispersed in the matrix may have a particle size of 0.1 to 0.5 microns, for instance, 0.1 to 0.2 microns.

Polymer

The composite particles comprise a matrix formed from an olefin polymer having acid and/or ester side groups. The acid groups may be derived from an acrylic acid (e.g. acrylic acid or methacrylic acid). The ester groups may be derived from an acrylate (e.g. acrylate or methacrylate). In one example, the polymer is a polymer of an olefin (e.g. ethylene) and an acrylic acid (e.g. acrylic acid or methacrylic acid) or acrylate (e.g. acrylate or methacrylate).

In one example, polymer is a polymer of an olefin (e.g. ethylene) and at least one monomer selected from an acrylic or acrylate monomer, for instance, methacrylic acid, acrylic acid, acrylate and methacrylate. The polymer may comprise at least 80 weight % olefin (e.g. ethylene), for example, 80 to 90 weight % olefin (e.g. ethylene). The polymer may include 10 to 20 weight % of an acrylic or acrylate monomer, for example, at least one of methacrylic acid, acrylic acid, acrylate and methacrylate.

In one example, the polymer is a polymer of an olefin (e.g. ethylene) and methacrylic acid. The polymer may include 80 to 90 weight % ethylene and 10 to 20 weight % methacrylic acid. The polymer may include 85 weight % ethylene and the remainder methacrylic acid. In one example, the polymer is or comprises a polymer sold under the trademark Nucrel® 925.

In one example, the polymer is a polymer of an olefin (e.g. ethylene) and acrylic acid. The polymer may include 80 to 90 weight % ethylene and 10 to 20 weight % acrylic acid. The polymer includes 82 weight % ethylene and the remainder acrylic acid. In one example, the polymer is or comprises a polymer sold under the trademark Nucrel® 2806.

In one example, the polymer resin may include more than one polymer. In an example, the polymer resin may include 2 or 3 polymers. In one example, the polymer comprises a polymer of an olefin (e.g. ethylene) and acrylic acid and a polymer of an olefin (e.g. ethylene) and methacrylic acid. For example, the polymer resin may include a first resin formed of 80 to 90 weight % ethylene and 10 to 20 weight % methacrylic acid, and a second resin formed of 80 to 90 weight % ethylene and 10 to 20 weight % acrylic acid. Where the polymer resin contains a first resin and a second resin, the amount of the first resin may be 60 to 80 weight %, for example, 65 to 75 weight % of the polymer resin mixture. The amount of second resin may be 15 to 25 weight %, for example, 17 to 22 weight % of the polymer resin mixture. The weight ratio the first resin to the second resin may be 2:1 to 5:1, for example, 3:1 to 4:

In one example, the polymer resin includes a first resin formed of 85 weight % ethylene and the remainder methacrylic acid, and a second resin formed of 82 weight % ethylene and the remainder acrylic acid. In one example, the polymer resin includes a mixture of a polymer sold under the trademark Nucrel® 925 and a polymer sold under the trademark Nucrel® 2806.

In addition to a copolymer of ethylene and at least one monomer selected from an acrylic or acrylate monomer e.g. as described above, the polymer may also include a terpolymer. The terpolymer may be a terpolymer of a) an olefin (e.g. ethylene), b) an acrylic acid (e.g. acrylic acid or methacrylic acid) or an acrylate (e.g. acrylate or methacrylate) and c) a polar monomer. The olefin (e.g. ethylene) may form 60 to 78 weight % of the terpolymer, for example, 65 to 70 weight % of the terpolymer. The acrylic acid (e.g. acrylic acid or methacrylic acid) or acrylate (e.g. acrylate or methyl acrylate) may form 20 to 35 weight % of the terpolymer, for example, 22 to 30 weight % of the terpolymer. The polar monomer may form the remainder of the terpolymer. Examples of suitable polar monomers include monomers containing amine, amide, ester, ether and/or anhydride functional groups. In one example, the polar monomer contains amide, amine, groups, anhydride groups or both ester and ether groups. In an example, the polar monomer is selected from maleic anhydride or glycidyl methacrylate.

In one example, the terpolymer is a terpolymer of ethylene, methacrylic acid and glycidyl methacrylate. The amount of ethylene may be 60 to 78 weight % of the polymer, for example, 65 to 70 weight % of the terpolymer. The amount of methacrylic acid may range from 20 to 35 weight % of the terpolymer, for example, 22 to 30 weight % of the terpolymer. The remainder of the polymer may be derived from glycidyl methacrylate. In one example, the terpolymer comprises 68 weight % ethylene, 24 weight % methacrylic acid and 8 weight % glycidyl methacrylate. The terpolymer may be one sold under the trademark Lotader® AX8900. The terpolymer may be used in combination with a copolymer of ethylene and methacrylic acid or acrylic acid. For example, such terpolymers (for instance one sold under the trademark Lotader® AX8900) may be employed in combination with polymers sold under the trademark Nucrel® 925.

In one example, the terpolymer is a terpolymer of ethylene, ethyl acrylate and maleic anhydride. The amount of ethylene may be 60 to 80 weight % of the terpolymer, for example, 65 to 70 weight % of the terpolymer. The amount of ethyl acrylate may range from 19 to 35 weight % of the terpolymer, for example, 20 to 30 weight % of the terpolymer. The remainder of the terpolymer may be derived from maleic anhydride. In one example, the amount of maleic anhydride may be 0.1 to 5 weight %, for example, 1 to 3 weight %. In one example, the terpolymer comprises 70 weight % ethylene, 29 weight % ethyl acrylate and 1.3 weight % maleic anhydride. The terpolymer may be used in combination with a copolymer of ethylene and methacrylic acid or acrylic acid. The terpolymer may be sold under the trademark Lotader® 4700. Alternatively, the polymer B may be one or more polymers sold under the trademark Lotader® 5500, Lotader® 4503 and Lotader® 4720. Such terpolymers (for instance one sold under the trademark Lotader® 4700) may be employed in combination with polymers sold under the trademark Nucrel® 925.

Where a terpolymer is employed, the terpolymer may form 1 to 50 weight % of the polymer resin. In some examples, the terpolymer forms 1 to 20 weight %, for instance 5 to 15 weight % of the polymer resin. Where a copolymer of an olefin (e.g.) and an acrylic or acrylate (e.g. methacrylic acid, acrylic acid, methacrylate or acrylate) is employed, the copolymer may form 50 to 100 weight %, for example, 70 to 99 weight %, for instance, 80 or 85 to 95 weight % of the polymer resin.

The polymer resin may have a melting point of less than 110 degrees C., for example, less than 100 degrees C. The polymer resin may have a melting point of 50 to 100 degrees C., for example, 60 to 95 degrees C. In one example, the polymer resin may have a melting point of 80 to 90 degrees C. Where the polymer resin contains a mixture of polymers, at least one of the polymers may have a melting point of less than 110 degrees C., for example, less than 100 degrees C. In some examples where the polymer resin contains a mixture of polymers, at least one of the polymers may have a melting point of 50 to 100 degrees C., for example, 70 to 95 degrees C. or 80 to 90 degrees C. In some examples, each of the polymers in the polymer resin mixture has a melting point of less than 110 degrees C., for example, less than 100 degrees C. In some examples, each of the polymers in the polymer resin mixture has a melting point of 50 to 100 degrees C., for example, 70 to 95 degrees C. or 80 to 90 degrees C.

The polymer resin may have a melting point that is lower than the melting point of the wax. For example, the polymer resin may have a melting point that is at least 10 degrees C. or 20 degrees C., for instance, at least 30 degrees C. lower than the melting point of the wax. In some examples, the polymer resin has a melting point that is at least 40 degrees C., for instance, at least 50 degrees C. lower than the melting point of the wax. The polymer resin may have a melting point that is no more than 100 degrees C., for instance, no more than 80 degrees C. or 70 degrees C. lower than the melting point of the wax. Where the polymer resin contains a mixture of polymers, each of the polymers in the mixture may have a melting point that is lower than the melting point of the wax, for example, by at least 20 or 30 degrees C. In some examples, each polymer in the polymer resin mixture has a melting point that is at least 40 degrees C., for instance, at least 50 degrees C. lower than the melting point of the wax. Each polymer in the polymer resin mixture may have a melting point that is no more than 100 degrees C., for instance, no more than 80 degrees C. or 70 degrees C. lower than the melting point of the wax.

The polymer resin may have (or may contain a polymer having) an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g can be measured using standard procedures known in the art, for example using the procedure described in ASTM D1386.

The resin may comprise a polymer that has a melt flow rate of less than about 70 g/10 minutes, in some examples about 60 g/10 minutes or less, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers each individually have a melt flow rate of less than 90 g/10 minutes, 80 g/10 minutes or less, in some examples 80 g/10 minutes or less, in some examples 70 g/10 minutes or less, in some examples 70 g/10 minutes or less, in some examples 60 g/10 minutes or less.

The resin may comprise a polymer having a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of, in some examples, about 50 g/10 minutes to about 120 g/10 minutes, in some examples 60 g/10 minutes to about 100 g/10 minutes. The melt flow rate can be measured using standard procedures known in the art, for example as described in ASTM D1238.

Where a terpolymer is present, this may have a melt index of 1 to 20 g/10 min, for instance, 1 to 9 g/10 or 10 g/10 min. In another example, the terpolymer has a melt index of 3 to 8 g/10 min, for instance, 4 to 7 g/10 min.

Where a copolymer of an olefin (e.g.) and an acrylic or acrylate (e.g. methacrylic acid, acrylic acid, methacrylate or acrylate) is employed, the copolymer may have a melt index of 20 to 200 g/10 min, for example, 25 to 70 g/10 min. In one example, the copolymer has a melt index of 25 to 35 g/10 min. This copolymer may be used in combination with another copolymer of an olefin (e.g.) and an acrylic or acrylate (e.g. methacrylic acid, acrylic acid, methacrylate or acrylate) having a melt index of 50 to 70 g/10 min.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic sides groups can be selected from resins such as co-polymers of ethylene and an ethylenically unsaturated acid of either acrylic acid or methacrylic acid; and ionomers thereof, such as methacrylic acid and ethylene-acrylic or methacrylic acid co-polymers which are at least partially neutralized with metal ions (e.g. Zn, Na, Li) such as ionomers sold under the trademark SURLYN®. The polymer comprising acidic side groups can be a co-polymer of ethylene and an ethylenically unsaturated acid of either acrylic or methacrylic acid, where the ethylenically unsaturated acid of either acrylic or methacrylic acid constitute from 5 wt % to about 25 wt % of the co-polymer, in some examples from 10 wt % to about 20 wt % of the co-polymer.

The resin may comprise two different polymers having acidic side groups. The two polymers having acidic side groups may have different acidities, which may fall within the ranges mentioned above. The resin may comprise a first polymer having acidic side groups that has an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 10 mg KOH/g to 110 mg KOH/g, in some examples 20 mg KOH/g to 110 mg KOH/g, in some examples 30 mg KOH/g to 110 mg KOH/g, in some examples 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The ratio of the first polymer having acidic side groups to the second polymer having acidic side groups can be from about 10:1 to about 2:1. The ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described in this disclosure. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 hz shear rate.

If the resin in the electrophotographic composition comprises a single type of polymer, the polymer (excluding any other components of the electrostatic composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The resin can constitute about 5 to up to 100 weight %, in some examples about 50 to 99%, by weight of the solids of the liquid electrophotographic composition. The resin can constitute about 60 to 95%, in some examples about 70 to 95%, by weight of the solids of the liquid electrophotographic composition.

### Composite Particles

As discussed above, the present disclosure also relates to a method of producing an electrophotographic composition. The process comprises mixing wax with a molten resin comprising an olefin polymer having acid and/or ester side groups and allowing the mixture to cool to form a matrix comprising an olefin polymer having acid and/or ester side groups surrounding dispersed particles of solid wax. The mixing may be carried out in the presence of a liquid carrier, for example, iso-paraffin.

Solid particles of wax may be mixed with the molten resin and dispersed, such that, when the molten resin cools and solidifies, solid particles of wax are dispersed in a resin matrix.

Alternatively, molten wax may be mixed with the molten resin. The wax has a melting point that is higher than the melting point of the olefin polymer in the matrix. Accordingly, even if the wax is mixed with the resin in a molten state, it forms solid particles upon cooling before the molten resin solidifies. In this way, particles of a solid wax are dispersed in a matrix of resin comprising the olefin polymer having acid and/or ester side groups.

Because solid particles are dispersed throughout the polymer matrix, it is possible to form a composite comprising “islands” of wax dispersed in a “sea” of polymer. Once cooled, the composite is ground to form composite particles, which are dispersed in a liquid carrier to form a liquid electrophotographic composition.

In one example, a polymer comprising or consisting of an olefin polymer having acid and/or ester side groups is melted. This melting step may be carried out at a temperature of 90 to 200 degrees C., for example, 100 to 150 degrees C. The melting step may be carried out while mixing. The melting step may also be carried out slowly over a prolonged period of time. In some examples, the polymer comprises 2 or more polymers. Accordingly, the melting step may be used to form a molten polymer mixture or blend.

Once molten, the polymer may be cooled, for example, under e.g. constant mixing. The polymer may be cooled to a temperature, whereby the polymer is still molten. For example, the polymer may be cooled to a temperature of 70 to 100 degrees C., for example, 80 to 90 degrees C.

Particles of wax or molten wax may be dispersed in the molten polymer. The wax has a melting point higher than the melting point of the polymer. Accordingly, if solid wax is mixed with the molten polymer, the wax can remain in solid form while it is dispersed in the molten polymer. In one example, the wax is dispersed in the polymer under high shear mixing. Once dispersed, the resulting mixture may be cooled, for example, gradually.

If molten wax is mixed with the molten polymer, the wax will solidify at a higher temperature than the polymer once the mixture is cooled. Accordingly, solid particles of wax are formed, which can be dispersed in the molten polymer during mixing.

Once cooled, the mixture may take the form of a paste, which may be ground to form composite particles. The mixture may be mixed with a charge adjuvant before grinding to form composite particles.

In some examples, the wax may be ground to form wax particles prior to addition to the molten polymer mixture. The wax may be ground in the presence of a charge adjuvant e.g. prior to addition to the resin. The composite particles may comprise wax and charge adjuvant dispersed in a polymer matrix.

### Charge Adjuvant

The liquid electrophotographic composition can include a charge adjuvant. A charge adjuvant may be present with a charge director, and may be different to the charge director, and act to increase and/or stabilise the charge on particles, e.g. resin-containing particles, of an electrostatic composition. The charge adjuvant can include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Cu salts of stearic acid, Fe salts of stearic acid, metal carboxylates (e.g. Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock co-polymers of 2-ethylhexyl methacrylate-co-methacrylic acid calcium, and ammonium salts, co-polymers of an alkyl acrylamidoglycolate alkyl ether (e.g. methyl acrylamidoglycolate methyl ether-co-vinyl acetate), and hydroxy bis(3,5-di-tert-butyl salicylic) aluminate monohydrate. In some examples, the charge adjuvant is aluminium di and/or tristearate and/or aluminium di and/or tripalmitate.

The charge adjuvant can constitute about 0.1 to 5% by weight of the solids of the liquid electrophotographic composition. The charge adjuvant can constitute about 0.5 to 4% by weight of the solids of the liquid electrophotographic composition. The charge adjuvant can constitute about 1 to 3% by weight of the solids of the liquid electrophotographic composition.

### Charge Director

A charge director may be added to the electrophotographic composition. In some examples, the charge director comprises nanoparticles of a simple salt and a salt of the general formula MAₙ, wherein M is a barium, n is 2, and A is an ion of the general formula [R₁—O—C(O)CH₂CH(SO₃⁻)C(O)—O—R₂], where each of R₁ and R₂ is an alkyl group e.g. as discussed above.

The sulfosuccinate salt of the general formula MAₙ is an example of a micelle forming salt. The charge director may be substantially free or free of an acid of the general formula HA, where A is as described above. The charge director may comprise micelles of said sulfosuccinate salt enclosing at least some of the nanoparticles. The charge director may comprise at least some nanoparticles having a size of 10 nm or less, in some examples 2 nm or more (e.g. 4-6 nm).

The simple salt may comprise a cation selected from Mg, Ca, Ba, NH₄, tert-butyl ammonium, Li⁺, and Al⁺, or from any sub-group thereof. In one example, the simple salt is an inorganic salt, for instance, a barium salt. The simple salt may comprise an anion selected from SO₄²⁻, PO³⁻, NO₃⁻, HPO₄²⁻, CO₃²⁻, acetate, trifluoroacetate (TFA), Cl⁻, Bf, F⁻, ClO₄⁻, and TiO₃⁴⁻, or from any sub-group thereof. In some examples, the simple salt comprises a hydrogen phosphate anion.

The simple salt may be selected from CaCO₃, Ba₂TiO₃, Al₂(SO₄)₃, Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄, or any sub-group thereof. In one example, the simple salt may be BaHPO₄.

In the formula [R₁—O—C(O)CH₂CH(SO₃⁻)C(O)—O—R₂], in some examples, each of R₁ and R₂ is an aliphatic alkyl group. In some examples, each of R₁ and R₂ independently is a 06-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R₁ and R₂ are the same. In some examples, at least one of R₁ and R₂ is C₁₃H₂₇.

In an electrophotographic composition, the charge director can constitute about 0.001% to 20%, in some examples 0.01 to 20% by weight, in some examples 0.01 to 10% by weight, in some examples 0.01 to 1% by weight of the solids of the electrostatic composition. The charge director can constitute about 0.001 to 0.15% by weight of the solids of the liquid electrophotographic composition, in some examples 0.001 to 0.15%, in some examples 0.001 to 0.02% by weight of the solids of the liquid electrophotographic composition. In some examples, the charge director imparts a negative charge on the electrostatic composition. The particle conductivity may range from 50 to 500 pmho/cm, in some examples from 200-350 pmho/cm.

### Carrier Liquid

Generally, the carrier liquid for the liquid electrophotographic composition can act as a dispersing medium for the other components in the electrostatic composition. For example, the carrier liquid can comprise or be a hydrocarbon, silicone oil, vegetable oil, etc. The carrier liquid can include, but is not limited to, an insulating, non-polar, non-aqueous liquid that can be used as a medium for toner particles. The carrier liquid can include compounds that have a resistivity in excess of about 10⁹ ohm-cm. The carrier liquid may have a dielectric constant below about 5, in some examples below about 3. The carrier liquid can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the carrier liquids include, but are not limited to, aliphatic hydrocarbons, is paraffinic compounds, paraffinic compounds, dearomatized hydrocarbon compounds, and the like. In some examples, the carrier liquid is an iso-paraffinic liquid. In particular, the carrier liquids can include, but are not limited to liquids sold under the trademarks, Isopar-G™, Isopar-H™, Isopar-L™, Isopar-M™, Isopar-K™, Isopar-V™, Norpar12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol300™ Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before printing, the carrier liquid can constitute about 20% to 99.5% by weight of the electrostatic composition, in some examples 50% to 99.5% by weight of the electrostatic composition. Before printing, the carrier liquid may constitute about 40 to 90% by weight of the electrostatic composition. Before printing, the carrier liquid may constitute about 60% to 80% by weight of the electrostatic composition. Before printing, the carrier liquid may constitute about 90% to 99.5% by weight of the electrostatic composition, in some examples 95% to 99% by weight of the electrostatic composition.

The composition when printed on the print substrate, may be substantially free from carrier liquid. In an electrostatic printing process and/or afterwards, the carrier liquid may be removed, e.g. by an electrophoresis processes during printing and/or evaporation, such that substantially just solids are transferred to the print substrate. Substantially free from carrier liquid may indicate that the ink printed on the print substrate contains less than 5 wt % carrier liquid, in some examples, less than 2 wt % carrier liquid, in some examples less than 1 wt % carrier liquid, in some examples less than 0.5 wt % carrier liquid. In some examples, the ink printed on the print substrate is free from carrier liquid.

### Colorants

The electrophotographic composition and/or ink printed on the print substrate may further include a colorant. The colorant may be selected from a pigment, dye and a combination thereof. The colorant may be transparent, unicolor or composed of any combination of available colours. The colorant may be selected from a cyan colorant, a yellow colorant, a magenta colorant and a black colorant. The electrophotographic composition and/or ink printed on the print substrate may include a plurality of colorants. The electrophotographic composition and/or ink printed on the print substrate may include a first colorant and second colorant, which are different from one another. Further colorants may also be present with the first and second colorants. The electrophotographic composition and/or ink printed on the print substrate may include first and second colorants where each is independently selected from a cyan colorant, a yellow colorant, a magenta colorant and a black colorant. In some examples, the first colorant includes a black colorant, and the second colorant includes a non-black colorant, for example a colorant selected from a cyan colorant, a yellow colorant and a magenta colorant. The colorant may be selected from a phthalocyanine colorant, an indigold colorant, an indanthrone colorant, a monoazo colorant, a diazo colorant, inorganic salts and complexes, dioxazine colorant, perylene colorant, anthraquinone colorants, and any combination thereof.

Where present, the colorant may be present in an amount of 0.1 to 10 weight %, for instance, 2 to 5 weight % of the total weight of solids of the composition.

In some examples, the electrophotographic composition is devoid of colorant. The electrophotographic composition may be a varnish composition that is electrophotographically printed over an image formed of an electrophotographic ink.

### Printing Process and Print Substrate

As mentioned above, the present disclosure also relates to a method of electrophotographically printing an image on a substrate. The method may comprise electrophotographically printing an electrophotographic ink composition onto a substrate to form an image; and electrophotographically printing an electrophotographic varnish composition as described in the present disclosure over the image.

In some examples, the liquid electrophotographic composition as described in this disclosure is printed onto a substrate using a liquid electrophotographic printer.

In some examples, the surface on which the image is formed or developed may be on a rotating member, e.g. in the form of a cylinder. The surface on which the printed image is formed or developed may form part of a photo imaging plate (PIP). The method may involve passing the composition between a stationary electrode and a rotating member, which may be a member having the surface having the (latent) electrostatic image thereon or a member in contact with the surface having the (latent) electrostatic image thereon. A voltage is applied between the stationary electrode and the rotating member, such that particles adhere to the surface of the rotating member. The intermediate transfer member, if present, may be a rotating flexible member, which may be heated, e.g. to a temperature of from 80 to 160° C.

The print substrate may be any suitable substrate. The substrate may be any suitable substrate capable of having an image printed thereon. The substrate may include a material selected from an organic or inorganic material. The material may include a natural polymeric material, e.g. cellulose. The material may include a synthetic polymeric material, e.g. a polymer formed from alkylene monomers, including, but not limited to, polyethylene and polypropylene, and co-polymers such as styrene-polybutadiene. The polypropylene may, in some examples, be biaxially orientated polypropylene. The material may include a metal, which may be in sheet form. The metal may be selected from or made from, for instance, aluminium (Al), silver (Ag), tin (Sn), copper (Cu), mixtures thereof. In an example, the substrate includes a cellulosic paper. In an example, the cellulosic paper is coated with a polymeric material, e.g. a polymer formed from styrene-butadiene resin. In some examples, the cellulosic paper has an inorganic material bound to its surface (before printing with ink) with a polymeric material, wherein the inorganic material may be selected from, for example, kaolinite or calcium carbonate. The substrate is, in some examples, a cellulosic print substrate such as paper. The cellulosic print substrate is, in some examples, a coated cellulosic print. In some examples, a primer may be coated onto the print substrate, before the electrostatic composition is printed onto the print substrate.

Various examples will now be described.

### EXAMPLES

### Example 1—Preparation of an Electrophotographic Composition Materials

The polymers, Nucrel® 925 (DuPont), Nucrel® 2806 (DuPont), and LOTADER® AX8900 (Arkema), were used as received. The high melting point paraffin wax, LANCO® 1400 SF (˜9 μm in average particle size), was purchased from Lubrizol and was used as received. The wax has a melting point of 140 degrees C.

a) Pre-Grinding of LANCO® 1400 SF:

33% NVS [non-volatile solids] slurry of LANCO® 1400 SF in an iso-paraffin solvent, Isopar®-L, was charged into an attritor. To this, was added charge adjuvant (1.6% of total mass) and ground at 250 RPM for 24 h. The final particle size was between 0.1-0.2 μm as determined by Malvern instrument.

b) Incorporation of LANCO® 1400 SF to form Composite Particles

In this method, the varnish resins (Nucrel® 925/Nucrel® 2806/LOTADER® AX8900 at 720/180/100 weight ratio, respectively) were melted under constant mixing at 140° C. The melt process was carried out slowly over an average of 2 hours. The resulting mixture was then cooled to 80° C. under constant mixing at a cooling rate of 0.5° C./minute.

5 wt % (to total resin mass) of the ground LANCO® 1400 SF (˜25% NVS [non-volatile solids] in Isopar 0) was added to the paste slowly under high-shear (10K, rpm) and constant mixing. The high-shear mixing allowed the wax to be dispersed in the highly-viscous resin melt. After 30 minutes, the high-shear mixing was stopped and cooling was continued at a rate of 0.1° C./minute under constant mixing. At 60° C., the melt turned into a white paste. The paste was cooled to 40° C. at 0.5° C./minute.

c) Preparation of Varnish Ink Solids:

1 kg of the corresponding paste at ˜42% NVS, 1.3 Kg of Isopar®-L and 7.0 grams of the charge adjuvant (aluminium tristearate, ˜1.6% on total solids) were loaded into an attritor containing metal (or ceramic) grinding balls. The grinding process was performed at 30° C. (mixing speed of 250 rpm) for 12-15 hours. After reaching the target particle size, the resulting slurry was diluted with Isopar-L and mixed for 1 h and discharged to a receiving container. The % NVS of the obtained varnish ink was in the range of 10-13%.

d) Preparation of Varnish Working Dispersion (WD)

A typical varnish ink solids (10-13%, NVS) in a ferry can was allowed to mix in a shaker (200 rpm) for at least 24 h prior to processing. A 2% NVS varnish ink is prepared by diluting a predetermined solid content with an iso-paraffinic carrier, Isopar®-L. The corresponding charge director (CD) was added at 2-15 mg/g (mg of CD per g of solid, w/w) and allowed to mix in a shaker (200 rpm) for 24 h to reach sufficient charging and homogenization.

### Comparative Example 2

As a comparative example, the procedure of Example 1 was repeated except that no LANCO® 1400 SF was added to the composition.

### Comparative Example 3

As a comparative Example, the procedure of Comparative Example 2 was repeated. However, in step c) the paste of varnish resins was ground with LANCO® 1400 SF powder for 16 hours at 30 degrees C. The LANCO® 1400 SF powder was not incorporated into the resin particle structure.

### Comparative Example 4

As a comparative Example, the procedure of Comparative Example 2 was repeated. However, in step d), a slurry of ground LANCO® 1400 SF powder was added to the working dispersion at a concentration of 5 weight % of the varnish composition. The LANCO® 1400 SF powder was not incorporated into the resin particle structure.

### Example 5

The procedure of Example 1 was repeated. However, instead of steps a) and b), the varnish resins (Nucrel® 925/Nucrel® 2806/LOTADER® AX8900 at 720/180/100 weight ratio, respectively) were melted under constant mixing at 140° C. together with LANCO® 1400 SF powder. The molten mixture is then cooled slowly under constant mixing to form a paste, which is formed into a working dispersion according to steps c) and d) of Example 1.

### Example 6—Peel Test

In this example, the adhesion (resistance to peel) of images varnished with the compositions of Example 1 and Comparative Example 2 were compared. An unvarnished image was used as a reference.

Adhesion was measured by a Peel Test. In this test, three identical pre-designed print patterns were electrophotographically printed onto print substrates. Each print pattern was formed of a series of printed rectangles with increasing ink coverage from 100% to 400%. An unvarnished print pattern was used as a reference, while the remaining two were varnished by electrophotographically printing a varnish composition according to Example 1 and Comparative Example 2 onto each of the print patterns, respectively.

10 minutes after printing, adhesive tape (Scotch® drafting tape #230, 3M, Canada) was applied onto each print pattern. The tape was smoothed over the print using a heavy roller. Thereafter, the tape was pulled swiftly away from the print substrate under constant force. The peel performance was assessed visually to determine the amount of remaining ink on the image. The higher the amount of ink left the better (better adhesion or peel performance).

The Peel Test was performed on two different coated print substrates, EuroArt® (Sappi) and Fortune Matte® (NewPage).

It was found that, for both substrates, the peel performance of print patterns varnished with the composition of Example 1 were far superior to the peel performance of print patterns varnished with the composition of Comparative Example 2. With the EuroArt® substrate, the peel performance of the print pattern varnished with the composition of Example 1 matched the peel performance of the reference (unvarnished) print pattern at coverages of 100% and 200%, and exceeded the peel performance of the reference at coverages of 300% and 400%. By way of comparison, the peel performance of the print pattern varnished with the composition of Comparative Example 2 was significantly inferior to that of the reference at all coverages. At coverages of 200%, 300% and 400%, virtually all the print was peeled off as a result of the Peel Test.

Similar findings were observed with the Fortune Matte® substrate. In fact, the peel performance print patterns varnished with the composition of Example 1 was better than that of the reference patterns at all coverages (100% to 400%). Print patterns varnished with the composition of Comparative Example 2 were almost completely removed at all coverages under the Peel Test.

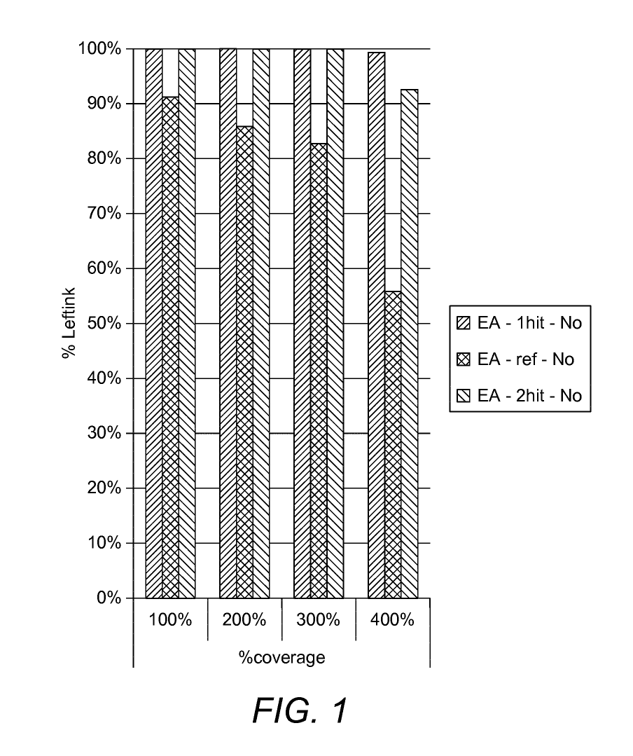

FIG. 1 is a bar chart showing the amount of ink remaining on the substrate after the Peel test of the reference print pattern and the print patterns varnished with the composition of Example 1. The print patterns varnished with the composition of Example 1 were either varnished with one layer of varnish (1 hit) or two layers of varnish (2 hits). As can be seen from the FIGURE, the print patterns varnished with the composition of Example 1 (1 hit or 2 hits) all showed superior peel performances to the reference.

### Example 7—Peel Test

In this example, the adhesion (resistance to peel) of images varnished with the compositions of Example 1, 5 and Comparatives Example 3 and 4 were compared by visual inspection. An unvarnished image was used as a reference.

Adhesion was determined by the Peel Test described in Example 6 above.

It was found that, for both substrates, the peel performance of print patterns varnished with the compositions of Examples 1 and 5 were superior to the peel performance of print patterns varnished with the composition of Comparative Example 3 despite the same amount of wax (5 weight %) being present in the composition. With Comparative Example 4, the peel performance at 1 hit was comparable to that achieved with Examples 1 and 5. However, at 2 hits, the peel performance deteriorated significantly and was far inferior to that achieved with Examples 1 and 5.

### Example 8—Scratch Resistance

As references, an unvarnished print circle was printed at 400% coverage at two different separations: YMCK and KYMC. The scratch resistance was evaluated by Taber® Shear instrument, which scratched the prints in a circular pattern using a tungsten carbide nail. The debris (ink removed by the nail) was weighed.

The test was repeated using varnished compositions, whereby 1 layer (1 hit) or 2 layers (2 hits) of an electrophotographic varnish according to Example 1 was applied to the unvarnished print circle. Without varnish, prints suffered the highest damage regardless of print separation orders. The average removed ink without the varnish was ca. 0.45 mg. Adding a single hit of varnish, on the other hand, improved greatly the resistance to scratch (debris weight drops from 0.45 mg to <0.18 mg). At 2 hits (˜2 μm varnish thickness) the amount of removed ink was very low and negligible, indicating a superior resistance to scratch. The damage visibility was proportional to the amount of removed ink, with 2 hits of varnish showing the least damaged prints.

The test was also repeated using varnished compositions, whereby 1 layer (1 hit) or 2 layers (2 hits) of electrophotographic varnish according to Comparative Examples 2, 3, 4 and Example 5 were applied to unvarnished print circles. By visual inspection, the scratch resistances of these varnished compositions were found to be comparable to the scratch resistances of the prints varnished with compositions of Example 1.

### Example 9—Rub Resistance

As a reference, an unvarnished rectangular area of print was subject to a standard ink rub test, whereby the area of print was rubbed with an eraser under specified conditions. The rub resistance of the print was observed.

The test was repeated with varnished rectangular areas of print, whereby 1 layer (1 hit) or 2 layers (2 hits) of an electrophotographic varnishes according to Examples 1 and 5 and Comparative Examples 2, 3 and 4 were applied to unvarnished rectangular areas of print. The varnished areas of print had rub resistances that were comparable to one another. However, the rub resistance of these varnished areas of print were superior to that of the unvarnished area of print, with the “2 hits” area or print showing the best rub resistance.

### Example 10—Preparation of a Further Electrophotographic Composition

The procedure of Example 1 was repeated using N, N-ethylene bis(stearamide) (melting point 144-146 degrees C.) as the wax in place of LANCO® 1400SF.

### Example 11—Peel Test

In this example, the adhesion (resistance to peel) of images varnished with the composition of Example 10 was determined.

Adhesion was measured by the Peel Test described in Example 6 above.

The Peel Test was performed on the coated print substrate, EuroArt® (Sappi).

It was found that the peel performance of print patterns varnished with the composition of Example 10 were comparable to the peel performance of print patterns varnished with the composition of Example 1.

### Comparative Example 11

The procedure of Example 1 was repeated using stearamide (CH₃(CH₂)₁₆C(O)NH₂, melting point 98 to 102 degrees C.) in place of LANCO® 1400SF.

### Comparative Example 12

The procedure of Example 1 was repeated using butyramide (C₃H₇CONH₂, melting point 114 to 116 degrees C.) in place of LANCO® 1400SF.

### Comparative Example 13

The peel test of Example 10 was repeated with images varnished with the compositions of Comparative Examples 11 and 12, respectively. It was found that the peel performance of print patterns varnished with the compositions of Comparative Examples 11 and 12 were significantly inferior to the peel performance of print patterns varnished with the composition of Example 10.

1. An electrophotographic composition comprising composite particles comprising particles of wax dispersed in a matrix comprising an olefin polymer having acid and/or ester side groups, wherein the wax has a melting point of at least 130 degrees C.

2. A composition as claimed in claim 1, wherein the wax forms 1 to 10 weight % of the total weight of the composite particles.

3. A composition as claimed in claim 1, which is an electrophotographic varnish composition.

4. A composition as claimed in claim 1, wherein the olefin polymer is a copolymer of ethylene and acrylic acid or methacrylic acid.

5. A composition as claimed in claim 1, wherein the matrix comprises a copolymer of ethylene and acrylic acid, a copolymer of ethylene and methacrylic acid and a terpolymer of ethylene, methyl acrylate and glycidyl methacrylate or a terpolymer of ethylene, ethyl acrylate and maleic anhydride.

6. A composition as claimed in claim 1, wherein the wax has a melting point of 135 to 150 degrees C.

7. A composition as claimed in claim 1, wherein the wax has a melting point that is at least 20 degrees C. higher than the melting point of the olefin polymer in the matrix.

8. A composition as claimed in claim 1, wherein the wax comprises an amide of a fatty acid.

9. A composition as claimed in claim 1, wherein the wax comprises ethylene bis(stearamide).

10. A composition as claimed in claim 1, wherein the composite particles contain a charge adjuvant dispersed within the matrix.

11. A method of producing an electrophotographic composition, said process comprising
mixing wax with a molten resin comprising an olefin polymer having acid and/or ester side groups,
allowing the mixture to cool to form a matrix comprising an olefin polymer having acid and/or ester side groups surrounding dispersed particles of solid wax, grinding the resulting mixture to form composite particles, and
dispersing the composite particles in a liquid carrier, wherein the wax has a melting point that is higher than the melting point of the olefin polymer in the matrix.

12. A method as claimed in claim 11, wherein particles of a solid wax are dispersed in a molten resin comprising an olefin polymer having acid and/or ester side groups.

13. A method as claimed in claim 11, wherein molten wax is mixed with molten resin.

14. A method as claimed in claim 11, wherein the wax has a melting point of at least 130 degrees C. and/or wherein the wax forms 1 to 10 weight % of the total weight of the composite particles.

15. Use of a wax having a melting point of at least 130 degrees C. to improve the adhesion of a varnished electrophotographically printed image onto a print medium.
